(19) United States
(12) Patent Application Publication
(10) Pub. No.: US 2025/0249526 A1
(43) Pub. Date: Aug. 7, 2025

(54) JOINED ASSEMBLY MANUFACTURING METHOD

(71) Applicant: TOYOTA JIDOSHA KABUSHIKI KAISHA, Toyota-shi (JP)

(72) Inventor: Yu SASAKI, Toyota-shi (JP)

(73) Assignee: TOYOTA JIDOSHA KABUSHIKI KAISHA, Toyota-shi (JP)

(21) Appl. No.: 18/952,143

(22) Filed: Nov. 19, 2024

(30) Foreign Application Priority Data
Feb. 1, 2024 (JP) 2024-014058

(51) Int. Cl. B23K 20/02; B23K 103/10

(52) U.S. Cl. CPC B23K 20/023; B23K 2103/10

(57) ABSTRACT

A joined assembly manufacturing method is a joined assembly manufacturing method for manufacturing a joining body of a cast product and a counterpart part, wherein the step of forming the cast product using a mold in which a plurality of dividing molds are combined, the step of providing a protrusion on the cast product based on a gap between the plurality of dividing molds, a step of placing a sealer on the protrusion, and a step of pressing the counterpart part against the cast product while crushing the protrusion in a state where the sealer is placed, the step of joining the cast product and the counterpart.

### CROSS-REFERENCE TO RELATED APPLICATION

This application claims priority to Japanese Patent Application No. 2024-014058 filed on Feb. 1, 2024, incorporated herein by reference in its entirety.

### BACKGROUND

### 1. Technical Field

The present disclosure relates to a joined assembly manufacturing method.

### 2. Description of Related Art

Various technologies have been proposed for casting that is one of forming processes for machine components. For example, there are technologies characterized by a process of forming a cast product, a mold to be used for casting, and a manufacturing method therefor.

Japanese Unexamined Patent Application Publication No. 2018-202442 (JP 2018-202442 A) discloses a mold apparatus including a mold body having a cavity for forming a molded product, and a temperature control device for controlling the temperature of the mold body. In this mold apparatus, the mold apparatus can be efficiently cooled or heated by dividing a portion of the mold body where the heat input amount increases or decreases from the other portion. Therefore, a desired mold temperature can be reproduced with a simple structure, and the accuracy of the thickness of the molded product can be improved.

### SUMMARY

A cast product may be joined to a counterpart component to be joined. In particular, to airtightly join the two components, the two components are pressed together with a sealer interposed therebetween. At this time, the sealer spreads radially in the joining plane of the two components regardless of the sealing direction. For this reason, a large amount of sealer may be required for joining.

The present specification realizes a joined assembly manufacturing method in which, when joining a cast product and a counterpart component with a sealer, the sealer is prevented from spreading in a random direction in a joining plane.

The joined assembly manufacturing method disclosed in the present specification is

a joined assembly manufacturing method of manufacturing a joined assembly of a cast product and a counterpart component. The joined assembly manufacturing method includes:
forming the cast product using a mold in which a plurality of divided molds is combined to provide a protrusion on the cast product based on a clearance between the divided molds;
placing a sealer on the protrusion; and
joining the cast product and the counterpart component by pressing the counterpart component against the cast product while crushing the protrusion with the sealer placed.

With the above structure, it is possible to prevent the sealer from spreading in a random direction in the joining plane.

The divided molds may be designed based on a predetermined portion for producing the protrusion.

With the above structure, the position where the sealer is to be placed can be set more accurately by setting the division plane of the divided molds at the portion where the protrusion is to be provided.

The clearance may be set by cutting a mating surface of the divided molds to a predetermined depth.

With the above structure, it becomes easier to set the portion where the protrusion is to be provided and the size of the protrusion.

The protrusion may have a thickness of 1 mm or less in a direction perpendicular to a surface to be pressed against the counterpart component.

With the above structure, the protrusion is easily crushed.

When the protrusion and the counterpart component are made of an aluminum alloy, the counterpart component may have a thickness of 3 mm or more.

With the above structure, even when the protrusion and the counterpart component are made of the same material, the protrusion is easily crushed by the difference in thickness.

With the joined assembly manufacturing method disclosed in the present specification, when joining the cast product and the counterpart component with the sealer, the sealer can be prevented from spreading in a random direction in the joining plane. As a result, unnecessary consumption of the sealer can be suppressed. In a case where the cast product is fastened with a bolt, it is possible to avoid bolt fastening failure due to the spreading of the sealer at the fastening portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a joined assembly manufacturing method according to an embodiment;

FIG. 2 is a diagram showing a comparative example without the protrusion shown in FIG. 1; and

FIG. 3 is a diagram showing another comparative example in a case where the protrusion shown in FIG. 1 is not provided.

### DETAILED DESCRIPTION OF EMBODIMENTS

Hereinafter, a joined assembly manufacturing method will be described with reference to the drawings.

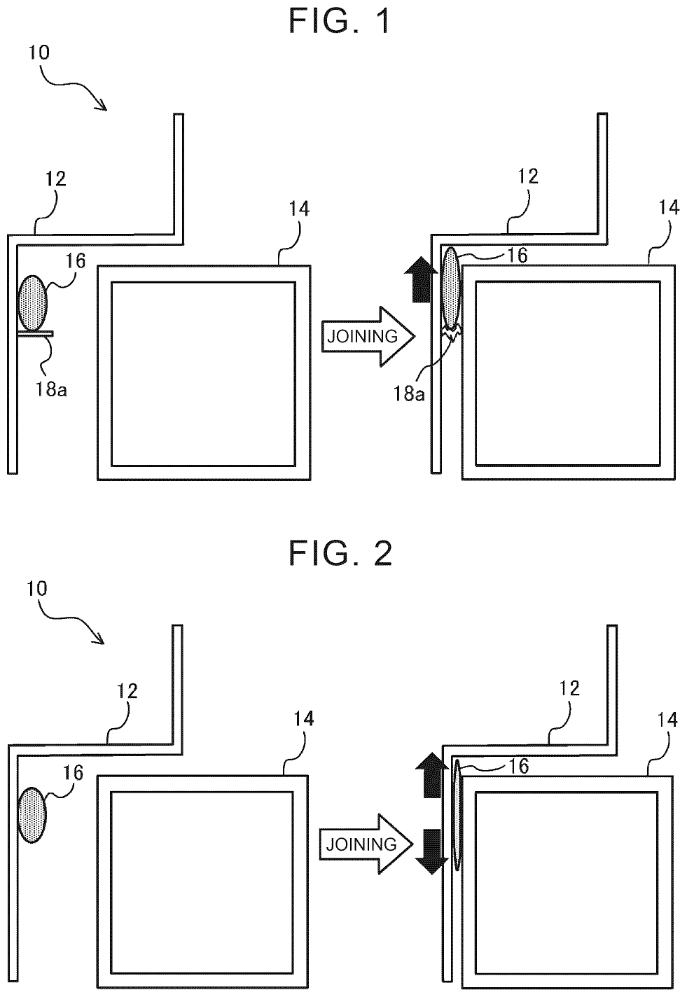

FIG. 1 is a diagram illustrating a joined assembly manufacturing method according to an embodiment. Before describing this manufacturing method, first, the structure of the joined assembly 10 will be described with reference to FIG. 1.

FIG. 1 shows a state of manufacturing the joined assembly 10 manufactured by the cast product 12 and the mating part 14. The cast product 12 shown in FIG. 1 is a cast product made of a conventional aluminum alloy. In addition, in the present example, the mating part 14 is also made of an aluminum alloy in the same manner as the cast product 12. As shown in FIG. 1, the cast product 12 is provided with a protrusion 18a. The protrusion 18a is set to be very thin so as to be crushed at the time of manufacturing the joined assembly 10 to be described later. Specifically, the protrusion 18a has a thickness of 1 mm or less in a direction perpendicular to the surface pressed against the mating part 14. On the other hand, the mating part 14 is set to have a thickness equal to or larger than 3 mm because a thickness sufficient to crush the protrusion 18a is required. Then, the protrusion 18a is pressed against the mating part 14 and crushed due to the thinness thereof, and then is leveled on the surface of the mating part 14. The joined assembly 10 illustrated in FIG. 1 is used for, for example, a vehicle body (specifically, a side sill, a wheel house, or the like). The shape of the joined assembly 10 is not particularly limited.

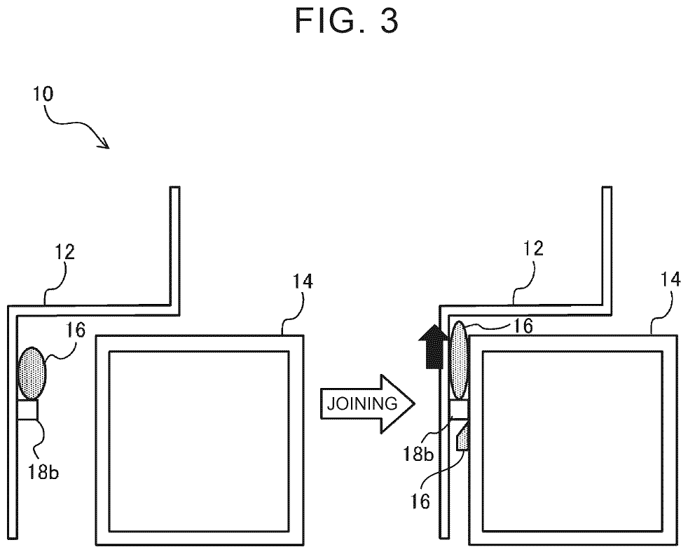

Next, a method of manufacturing the joined assembly 10 will be described with reference to FIG. 1. First, the cast product 12 is formed using a mold in which a plurality of divided molds are combined. At this time, the dividing mold is designed based on a predetermined portion for generating a protrusion 18a, which will be described later. Next, a protrusion 18a is provided on the cast product 12 based on the gap between the plurality of divided molds. The gap may be set by shaving the mating surfaces of the plurality of divided molds to a predetermined depth. When the protrusion 18a is formed, the sealer 16, which is a sealing material for suppressing the ingress or leakage of a liquid or a gas, is applied (that is, the sealer 16 is placed on the protrusion 18a). When the cast product 12 and the mating part 14 cannot be sealed by the sealer 16, for example, rainwater may enter and rust may be induced in the vehicle body, and the rust may cause breakage of the structure. Therefore, when the joined assembly 10 is joined, a structure in which a gap is not generated by pressing the mating part 14 against the sealer 16 applied to the cast product 12 is aimed. In this embodiment, the mating part 14 is pressed against the cast product 12 while crushing the protrusion 18a, thereby joining the cast product 12 and the mating part 14. In FIG. 1, the sealer 16 is shown as a thin ink portion, but the same applies to FIGS. 2 and 3, which will be described later.

In FIG. 1, the left side of the open arrow indicated as “join” in the center of FIG. 1 indicates the state before joining of the cast product 12 and the mating part 14, and the right side of the arrow indicated as “join” indicates the state when the cast product 12 and the mating part 14 are joined. In the joined assembly manufacturing method according to the embodiment shown in FIG. 1, when the joined assembly 10 is joined, the protrusion 18a is sandwiched between the joining surfaces of the cast product 12 and the mating part 14, and is crushed, so that the sealer 16 is set so as not to spread randomly at the joining surface. The spreading direction of the sealer 16 is indicated by a black arrow in FIG. 1. That is, although the cast product 12 has a low flatness, by the protrusion 18a crushed between the cast product 12 and the mating part 14 is sandwiched, the surface facing the mating part 14 of the protrusion 18a (hereinafter, referred to as the line end surface of the protrusion 18a) is leveled on the surface of the mating part 14, it is possible to seal between them. In other words, the protrusion 18a is utilized as an embankment that prevents leakage of the sealer 16 during joining. As a result, in the structure of the joined assembly 10 shown in FIG. 1, the spreading of the sealer 16 in the random direction can be suppressed, and the spreading in the downward direction can also be controlled, so that unnecessary consumption of the scaler 16 and poor bolt fastening can be avoided.

Next, a comparative example with the joined assembly manufacturing method according to the embodiment will be described with reference to FIGS. 2 and 3. In FIGS. 2 and 3, the same components as those in FIG. 1 are denoted by the same reference numerals, and description thereof will be omitted as appropriate. FIG. 2 is a diagram showing a comparative example in a case where the protrusion shown in FIG. 1 is not provided. Similar to FIG. 1, the left side of the open arrow indicated as “Join” in the center of FIG. 2 indicates the state before joining of the cast product 12 and the mating part 14, and the right side of the arrow indicated as “Join” indicates the state when the cast product 12 and the mating part 14 are joined.

As shown in FIG. 2, a sealer 16 is applied to a part of the surface of the cast product 12 that faces the mating part 14. Here, as shown in the view of the state at the time of joining in FIG. 2, the sealer 16 spreads in the up-down direction at the joining surface between the cast product 12 and the mating part 14. In FIG. 2, the spreading direction of the scaler 16 is indicated by a black arrow. That is, in the structure of the joined assembly 10 shown in FIG. 2, the spreading of the sealer 16 in the up-down direction cannot be suppressed and spreads randomly. This is due to the low flatness characteristic of the casting. Therefore, a larger amount of sealer 16 than is required for sealing, and in some cases, a larger amount of scaler may be applied to the coating surface of the cast product 12.

Further, since the sealer 16 extends beyond a necessary portion, a problem may arise in addition to the unnecessary consumption of the sealer 16 as described above. For example, the spreading of the sealer 16 at a portion fastened with a bolt may cause a bolt fastening failure. Therefore, for example, there is another configuration of the joined assembly 10 as shown in FIG. 3. FIG. 3 is a diagram showing another comparative example in a case where the protrusion shown in FIG. 1 is not provided. In other words, FIG. 3 is a diagram showing one method corresponding to the problem of the joined assembly manufacturing method shown in FIG. 2. In FIG. 3, the same components as those in FIGS. 1 and 2 are denoted by the same reference numerals, and description thereof will be omitted. Further, as in FIGS. 1 and 2, the left side of the white arrow shown as “join” in the center of FIG. 3 shows the state before joining of the cast product 12 and the mating part 14, the right side of the arrow shown as “join” shows the state at the time of joining the cast product 12 and the mating part 14. A protrusion 18b is provided on a part of a surface of the cast product 12 illustrated in FIG. 3 that faces the mating part 14. The sealer 16 is placed on the protrusion 18b. That is, in the process shown in FIG. 3, at the time of joining the joined assembly 10, by the protrusion 18b is sandwiched between the joining surface of the cast product 12 and the mating part 14, the sealer 16 extends only in the upward direction than the protrusion 18b, aiming at a configuration so as not to spread downward. The direction in which the sealer 16 spreads in the intended configuration is indicated by a black arrow in FIG. 3. However, actually, since the cast product 12 has a lower flatness, it is difficult to bring the surface of the mating part 14 and the surface facing the mating part 14 of the protrusion 18b (hereinafter, referred to as the line end surface of the protrusion 18b) into close contact with each other. That is, since it is difficult to form the line end surface of the protrusion 18b so as to be leveled on the surface of the mating part 14, a gap is generated between the line end surface of the protrusion 18b and the surface of the mating part 14. In this case, as shown in the view of the state at the time of joining in FIG. 3, the sealer 16 leaks from the gap and also partially spreads in the downward direction. That is, in the structure of the joined assembly 10 shown in FIG. 3, even if the spreading of the sealer 16 in the random direction can be suppressed somewhat, the spreading in the downward direction cannot be controlled, and the problem of unnecessary consumption of the sealer 16 and poor bolt fastening cannot be solved.

As described above, compared with the joined assembly manufacturing method shown in FIGS. 2 and 3 which are comparative examples, in the joined assembly manufacturing method according to the embodiment shown in FIG. 1, the sealer at the bonding surface can be set so as not to spread in the random direction. In the joined assembly manufacturing method according to the embodiment, it is possible to reduce the number of processes excluding burrs. In general, when a cast product is formed using a mold in which split molds are combined, burrs are generated due to positional deviation between the split molds that are in contact with each other at the split surfaces. In this case, another process for suppressing the generation of burrs in the dividing surface may be considered, or a process for removing the burrs generated may be added. However, in the present embodiment, by intentionally generating the burr as a protrusion 18a at a predetermined position, it is possible to utilize the burr itself, it is possible to avoid the addition of unnecessary steps.

Incidentally, the above description is an example, in the joined assembly manufacturing method disclosed in this specification, while crushing the projection portion provided on the casting in a state of placing the sealer, pressing the mating part to the casting, it may be a method of joining the casting and the mating part. Therefore, other configurations may be changed as appropriate.

For example, in the embodiment, the counterpart component is described as an aluminum alloy in the same manner as the cast product, but the material of the counterpart component is not particularly limited. For example, when the mating part is made of iron, sufficient force is applied to crush the projections made of an aluminum alloy, so that the dimensions of the mating part are not limited.

In the embodiment, since the position at which the sealer is placed can be more accurately set by setting the division surface of the division mold at the position where the projection is desired to be provided, the division mold is used. In addition, since the use of a large mold (for example, a 1 m four-way mold) increases the cost, a split mold is used from the viewpoint of cost reduction. That is, since it is only necessary to set the position where the protrusion is generated as a target, the shape and size of the dividing mold is not particularly limited.

What is claimed is:

1. A joined assembly manufacturing method of manufacturing a joined assembly of a cast product and a counterpart component, the joined assembly manufacturing method comprising:
forming the cast product using a mold in which a plurality of divided molds is combined to provide a protrusion on the cast product based on a clearance between the divided molds;
placing a sealer on the protrusion; and
joining the cast product and the counterpart component by pressing the counterpart component against the cast product while crushing the protrusion with the sealer placed.

2. The joined assembly manufacturing method according to claim 1, wherein the divided molds are designed based on a predetermined portion for producing the protrusion.

3. The joined assembly manufacturing method according to claim 1, wherein the clearance is set by cutting a mating surface of the divided molds to a predetermined depth.

4. The joined assembly manufacturing method according to claim 1, wherein the protrusion has a thickness of 1 mm or less in a direction perpendicular to a surface to be pressed against the counterpart component.

5. The joined assembly manufacturing method according to claim 4, wherein when the protrusion and the counterpart component are made of an aluminum alloy, the counterpart component has a thickness of 3 mm or more.
